(19) United States
(12) Patent Application Publication
(10) Pub. No.: US 2017/0053036 A1
(43) Pub. Date: Feb. 23, 2017

(54) Different apps on different mobile devices interacting via deep links

(71) Applicant: Wesley John Boudville, Los Angeles, CA (US)

(72) Inventor: Wesley John Boudville, Los Angeles, CA (US)

(21) Appl. No.: 14/756,208

(22) Filed: Aug. 18, 2015

(51) Int. Cl. G06F 17/30; H04L 29/08

(52) U.S. Cl. CPC G06F 17/30887; H04L 67/141; H04L 67/18; G06F 17/30882; G06F 17/30879

(57) ABSTRACT

Many social apps on mobile devices let a user find others nearby using the same app. But her app cannot find users running other apps. The invention has the app servers implementing an API. Her app server sends her location and other criteria to other servers. They return deep links and other data about their users near her. If she picks a user, his deep link is run. It has a name of his app and an identifier of his app instance, like a network address. Her app makes a subwindow where she interacts with him via the app server/s or directly between the app instances. This improves the value of both apps, by increasing audiences accessible to users of either app. Her app can use the deep link to install an instance of his app, and then start it. So her interaction with him uses entirely his app. Her first app server can be compensated by the second server for the installation. The invention can also be used for task based or transactional apps, like those for finding taxi rides or people to do chores. The problem of transient deep links is addressed. Where a deep link referring to an address of a mobile device expires when the device gets a new network address. A deep link can be forwarded, with the forwarded app appending a deep link about itself to the original link. A deep link can be rated by a Rater website using ratings of the app that it refers to, and a rating of the app instance address in the deep link. The Rater has data to make a social network and for a search engine.

### REFERENCES CITED

“Apps everywhere but no unifying link” by C. Dougherty, New York Times, 5 Jan. 2015. “Deep linking's big untapped potential” by M. Thomson, VentureBeat.com, 9 Aug. 2015. “Generating and presenting deep links” by V. Tankovich et al, US Patent Application 20130110815 (Oct. 28, 2011).

“Methods and systems for facilitating an online social network” by C. Evans, US Patent Application 20140089413 (Dec. 6, 2013).
“Text-synchronized media utilization and manipulation based on an embedded barcode” by C. Evans, US Patent application 20130334300 (Mar. 27, 2013). “Smart link system and method” by J. Chor, U.S. Pat. No. 8,433,800, (28 Feb. 2011).

### TECHNICAL FIELD

The field is using deep links for mobile apps.

### BACKGROUND

Mobile apps have a distinctive problem. Most are currently standalone programs, that often just converse with an app server run by the company that wrote the app. The apps do not have URL links within them.

It is much harder for a search engine, which is optimised to search the Web for webpages, to search arbitrary apps. There is no standard syntax equivalent to an URL or URI to enable this.

To enable such and other functionality in mobile apps has been termed ‘deep linking’ within apps. (The term also has an earlier use that refers to standard web pages and URL links within them. This submission does not use that earlier meaning.)

Major companies have several projects aimed at defining deep links. Facebook Corp. has App Links. Google Corp. has App Indexing and Google Intents. Twitter Corp. has App Cards. Apple Corp. has Apple Extensions. There are also several startups, like Branch Metrics Corp., Quixy Corp., URX Corp., and Tapstream Corp., each with their own initiatives. The syntax and functionality vary between these company specific efforts.

### SUMMARY

Many social apps on mobile devices let a user find others nearby using the same app. But her app cannot find users running other apps. The invention has the app servers implementing an API. Her app server sends her location and other criteria to the other servers. They return deep links and other data about their users near her. If she picks a user, his deep link is run. The deep link has a name of his app and an identifier of his app instance, like a network address. Different deep link formats could be used.

Her app makes a subwindow where she interacts with him via the app server/s or directly between the app instances. This improves the value of both apps, by increasing the audiences accessible to the users of either app.

An alternative is for her app to install the app that the other user is running on his device, if the app is not already present on her device. The app is run with the other arguments of the deep link. Her original app can be compensated by the other user's app server, for helping install and run an instance of its app.

The submission can also be used for task based or transactional apps, like those for finding taxi rides or people to do chores. Users of those apps can bid on her task. The bids can be sorted in part by the bid amounts.

Suppose a user Bob makes a deep link referring to an app on his device. The deep link has the current address of his device. Bob moves and his device gets a new network address. This is the “transient deep link” problem. The deep link is outdated. In solution, the app server keeps a record of a permanent id of Bob's device or him and stores any network addresses of the device. If another user runs the old deep link, it does not connect to anything. Her device then sends the deep link to the server. It replies with the new current address of Bob's device. Letting her device make a valid current deep link in order to interact with Bob's app.

A deep link gotten by a user can be forwarded to another user. The first user can append her network address and possibly her app identifier to the deep link. She can sign it with her private key. The person who gets the deep link can interact with the user who made the original deep link. He made the original deep link. He can also make a social network graph from the deep link he got, of the forwarding network.

A deep link can have a rating. This can be a combination of a rating of the app and a rating of the network address of the instance of the app. The rating of the app can be done by a Rater website using the app stores. Antispam organisations can be used by the Rater to find a rating of the app instance address. The Rater also collects reviews of deep links by the end users. The Rater gathers social network data and search engine data.

### BRIEF DESCRIPTION OF THE DRAWINGS

FIG. 1 is the prior art of 2 users using the same social app to find each other.

FIG. 2 shows several users with mobile devices running social apps.

FIG. 3 shows an app server interacting with other app servers.

FIG. 4 shows a screen in an app listing nearby users.

FIG. 5 shows a deep link with a string id for the app instance.

FIG. 6 shows a deep link with an app network address.

FIG. 7 shows a text chat window in an app, interacting with another user.

FIG. 8 shows a registry having subregistries with different APIs.

FIG. 9 shows how to connect to an unmodified app.

FIG. 10 shows an app installing another app.

FIG. 11 shows a transient deep link.

FIG. 12 shows forwarding of a deep link.

FIG. 13 is a social network graph derived from FIG. 12.

FIG. 14 is a rating of a deep link.

### DETAILED DESCRIPTION OF THE PREFERRED EMBODIMENT

What we claim as new and desire to secure by letters patent is set forth in the following claims. □

This submission refers to our earlier submissions to the US PTO: “Cellphone changing an electronic display that contains a barcode”, filed 16 May 2011, U.S. Pat. No. 8,532,632 [“1”]; □ “Using dynamic barcodes to send data to a cellphone”, filed 28 Jul. 2011, U.S. Pat. No. 8,348,149 [“2”]; “Transmitting and receiving data via barcodes through a cellphone for privacy and anonymity”, filed 4 Oct. 2011, U.S. Pat. No. 8,707,163 [“3”]; “Colour barcodes and cellphone”, filed 16 Dec. 2011, U.S. Pat. No. 8,821,277 [“4”]; “Mobile device audio from an external video display using a barcode”, filed 25 May 2012, U.S. Pat. No. 8,708,224 [“5”]; “Dynamic group purchases using barcodes”, filed 29 May 2012, U.S. Pat. No. 8,655,694 [“6”]; “Chirp to control devices”, filed 9 October 2012, US patent application 20140098644 [“7”]; “Barcode-based methods to enhance mobile multiplayer games”, filed 22 May 2013, US patent application 20140349746 [“8”]; “Barcode, sound and collision for a unified user interaction”, filed October 2013, US patent application 20150113068 [“9”], “Deep linking of mobile apps by barcode, sound or collision”, filed Feb. 18, 2015, U.S. patent application Ser. No. 14/544,763 [“10”], “Cookies and anti-ad blocker using deep links in mobile apps”, filed Jun. 8 2015, U.S. patent application Ser. No. 14/545,694 [“11”]; “Blockchain and deep links for mobile apps”, US patent application [“12”].

In recent submissions 10, 11 and 12, we described deep links and ways that these could enhance interactions between two mobile devices near each other. The current submission describes more ways for mobile interactions. Primarily now the devices need not necessarily be close to each other. And where one of the devices need not be mobile.

We define some terminology.

This submission is mostly about mobile devices carried or worn by people. The most common mobile device is a cellphone. We take this word to also include “smartphone”. The latter term arose to describe a cellphone that also had a camera and Internet access, when such features were relatively new to cellphones. Other types of mobile devices are tablets, laptops, notebooks, netbooks, PDAs and wearable devices.

We will make frequent references to “app store” and “app server”. Despite the similarity in names, these are different entities. An app store is typically run by a maker of a mobile device (like Apple Corp., Microsoft Corp.), or a provider of an operating system for mobile devices (like Google Corp.). Software companies that make mobile apps submit these to an app store. So users can find the apps in the app store and download them to the mobile devices. An app server is a server run by one of those software companies. A mobile user can use her device browser to go to the website of the app server, to download the app.

When we later describe an instance of an app interacting with an instance of another app, we might say, for brevity, a statement like “the first app interacts with the second app”, when strictly it should be “an instance of the first app interacts with an instance of the second app”. There should be no confusion with the use of the shorter phrase. But when 2 instances of an app interact with each other, a more precise phrasing is needed, like “a first instance of the app interacts with a second instance of the app”.

This submission has the following sections.

1: Introduction;

2: Variants;

3: Task based or transactional apps;

4: Server registry;

5: Deep link for installing an app;

5.1: Installing an app before interaction;

5.2: Installing an app after interaction;

6: Transient deep link;

7: Forwarding a deep link;

8: Rating a deep link;

9: Remarks;

1: Introduction;

Much prior art on deep links has focused on essentially one use case. A user, Jane, has a mobile device. She runs an app that shows, for example, images or video of the Grand Canyon. While watching this nature app, she might be interested in buying a ticket to visit the location. She brings up an option that shows a button or link. This is implemented as a deep link. When she picks it, the nature app by some means causes an install of an app made by a travel agency. The travel app is started and goes to a page or screen about the Grand Canyon. Jane can buy a ticket to visit. The nature and travel apps are written by different groups.

Both apps run on the same device. In contrast, our earlier submissions 10, 11 and 12 looked at different scenarios. These involved apps running on two devices, each device with a different user. A large part discussed 2 instances of the same app. With a natural example of multiplayer games.

Another difference between the prior art and our submissions is that in the former, the programmatic interaction between 2 apps on the same device is very limited. It amounts to a first app somehow using a deep link to start a second app on the same device. The second app may get an input parameter (from the deep link) that tells it what page to show when it starts. But beyond this, any subsequent interaction between the user and the second app does not have the second app programmatically interact with the first app. Nor does the first app have any further interaction with the second app.

Also at this time of writing, mobile gaming has largely deprecated the mooted use of deep links. If the first app that Jane runs is a game and it has a deep link that causes her device to run a second app on her device, to which presumably she gives her attention, then the game on the first app is at best suspended. At worst, if the game demands her constant attention, she might lose the game. If not this, then her score in the game could be non optimal because it does not have her full attention.

The present submission looks at the case of 2 different apps, each running on a different mobile device. The apps can be considered social apps, though not exclusively.

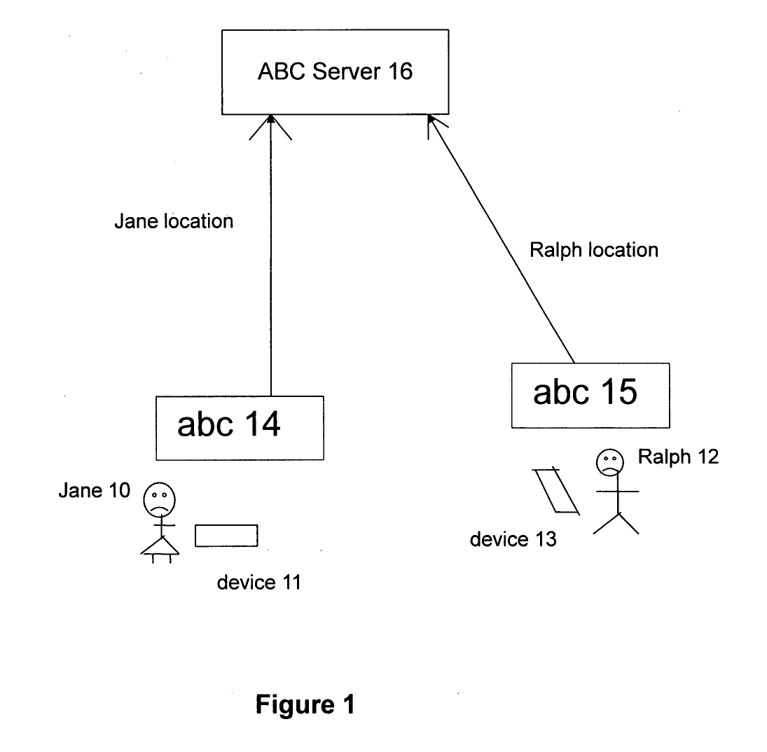

In the prior art, we have FIG. 1. It shows Jane 10 with her device 11 and Ralph 12 with his device 13. Both run different instances of the same app. Jane runs instance abc 14 and Ralph runs abc 15. Each instance periodically sends its device location to abc server 16. The typical use case is Jane is in some public location, like a bar or mall. She wants to find other users of the same app who might be nearby. Her instance abc 14 uploads her location and possibly some radius. The server then downloads some information about other users like possibly Ralph, who are within this radius.

There are elaborations. Often, each user at some earlier time has uploaded personal information. So Jane might get some information about Ralph, and decides if she wants to meet him. If so, by some means via the app server, their locations are revealed to each other.

There are many such apps, with many variations, mostly minor. However they often involve the users having to install and use the same app. A social network effect. The problem for such an app when it is newly introduced to the marketplace is how to garner enough users for the chances of interacting with another user to be usefully significant. At this time, there are over a million apps for Android and Apple.

Hence there is merit in users of different social apps being able to interact with each other, even when they have different apps. This is the basic motivation or utility of this submission.

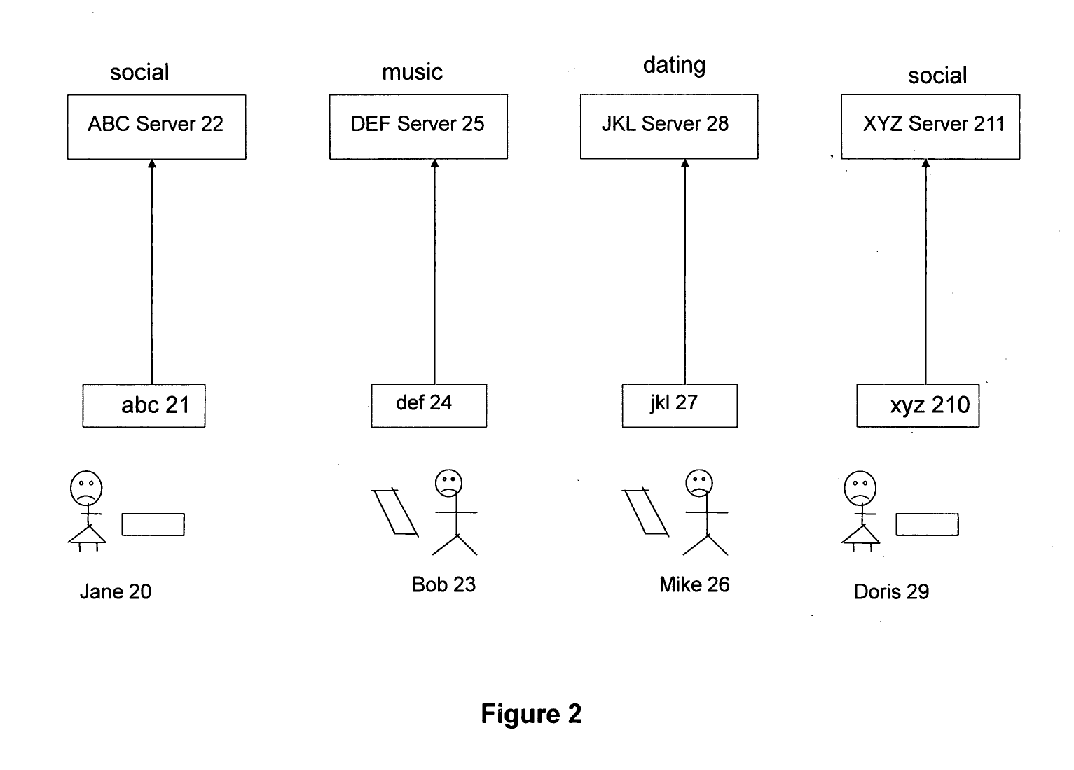

FIG. 2 shows 4 users, each with a mobile device and each running a different social app. Jane 20 runs app abc 21, which talks to abc server 22. App abc is a social app. Bob 23 runs app def 24, which talks to def server 25. This is a music app, where users of different music styles might interact. Mike 26 runs app jkl 27, which talks to jkl server 28. This is a dating app. Doris 29 runs app xyz 210, which talks to xyz server 211. This is a social app. For simplicity, FIG. 2 depicts each user and mobile device, but we do not label the mobile devices separately.

Each app can have the above prior art property, where users of the same app can find each other.

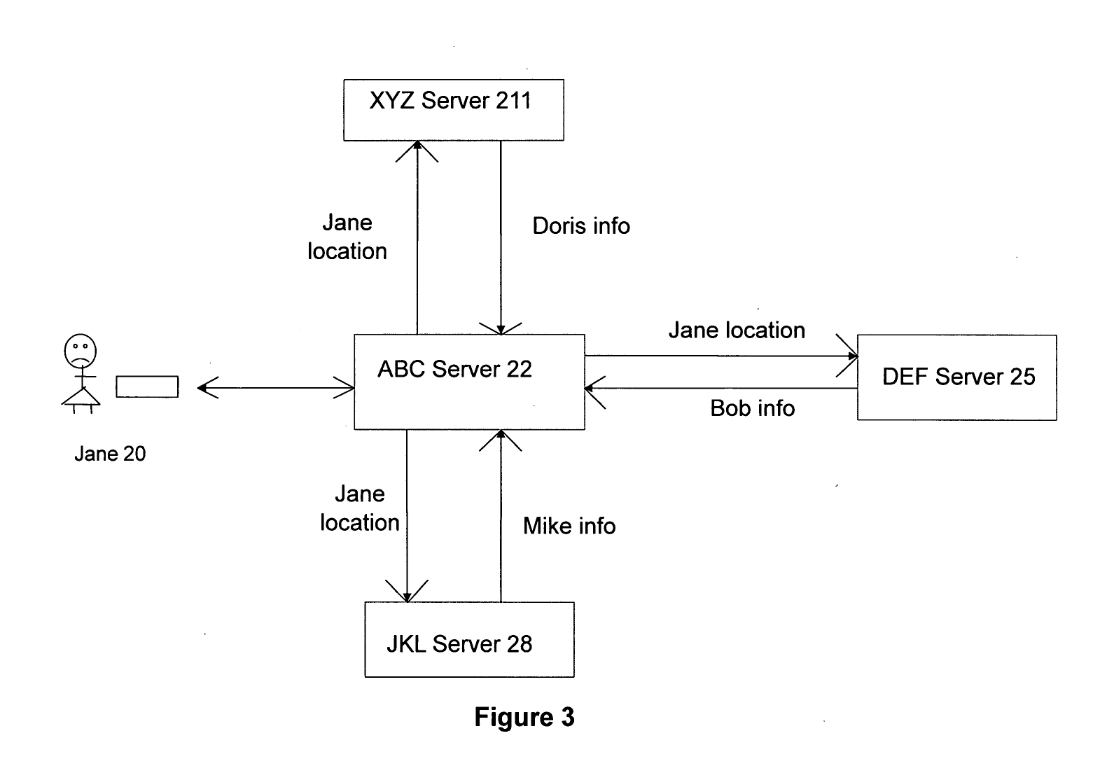

Consider Jane. She is in a public place and wants to meet people of similar interests. See FIG. 3. Her device uploads her location to abc server 22. One situation is that an Application Programming Interface (API) exists, and is implemented by def server 25, jkl server 28 and xyz server 211. This lets abc server 22 query each server. ABC server sends a location perhaps along with some other parameter that is a proximity measure. This might be a radius, with the meaning that Jane is interested in users within this radius of the location. Another proximity measure could be a geofence, with the meaning that Jane is interested in users inside the area defined by the geofence.

Most often, the location would be Jane's current location, as ascertained by her device via some geolocation mechanism. But the location might be a landmark like a shopping mall or cinema or the intersection of 2 streets. Jane might intend to be at that location in the (near) future and wants to see who else might be there or is already there.

There might be other data about Jane, like her sex and hobbies. This data might be sent once, at some earlier time, and would only be updated occasionally.

For simplicity, FIG. 3 depicts that only Jane's location is uploaded to the other servers. In general, other data about her could be sent, suitably anonymised if appropriate.

Each server replies with a list of its suitable members within proximity of Jane. Each member might be described by data like the person's sex, nickname, age and image. Of the servers that are assumed to reply to abc server, the data returned about members might vary. For example, the music server def might not return an image of a member. While the dating server jkl might show an image. In other words, the API acknowledges that different social apps might return different types and amounts of data about members.

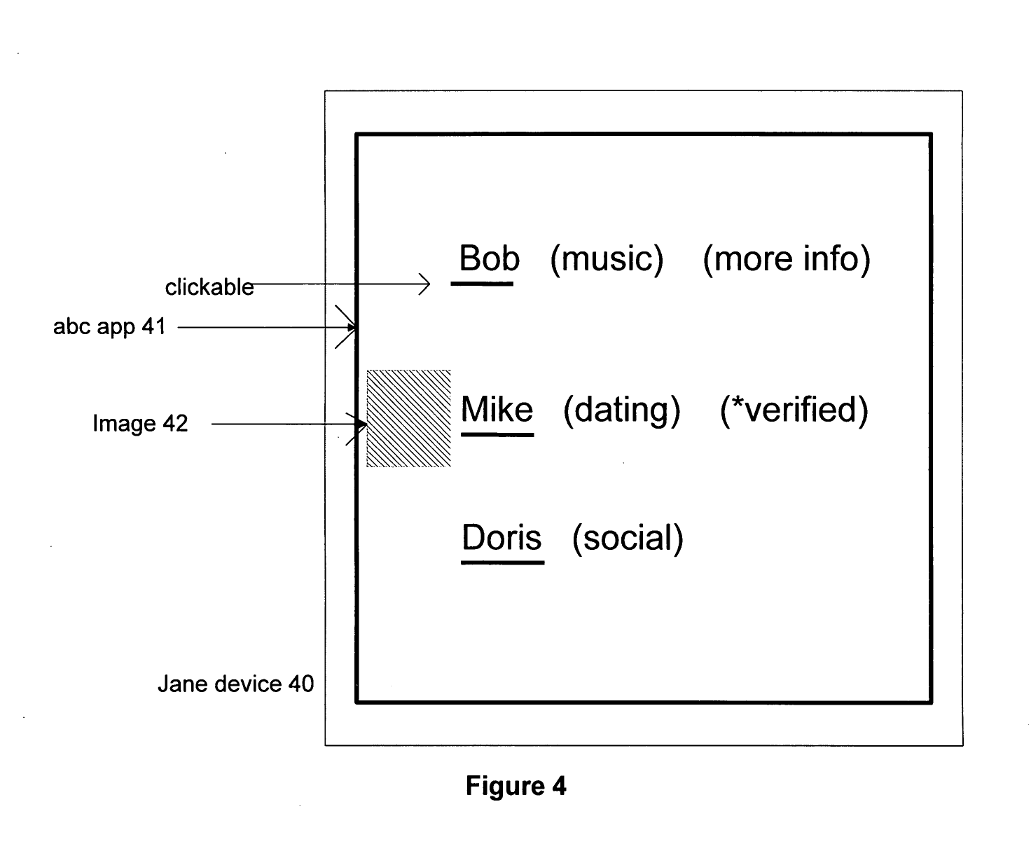

In FIG. 3, abc server could download this data to Jane's app. For simplicity, suppose her app gets only one user from each of the other servers via this method. FIG. 4 shows a screen shot of Jane device 40. In it is the screen of abc app 41. Three users, Bob, Mike and Doris are shown. Under each name is an underline, which designates to Jane that she can pick each of this, like a link in a web page. Next to each user's name (this can be a nickname) is more information. For Mike, there is “(* verified)”, which means that his server has verified his real identity. For some types of social apps, especially dating, this could be an important consideration for users. Also, for Mike, there is image 42, which could be a photo of him.

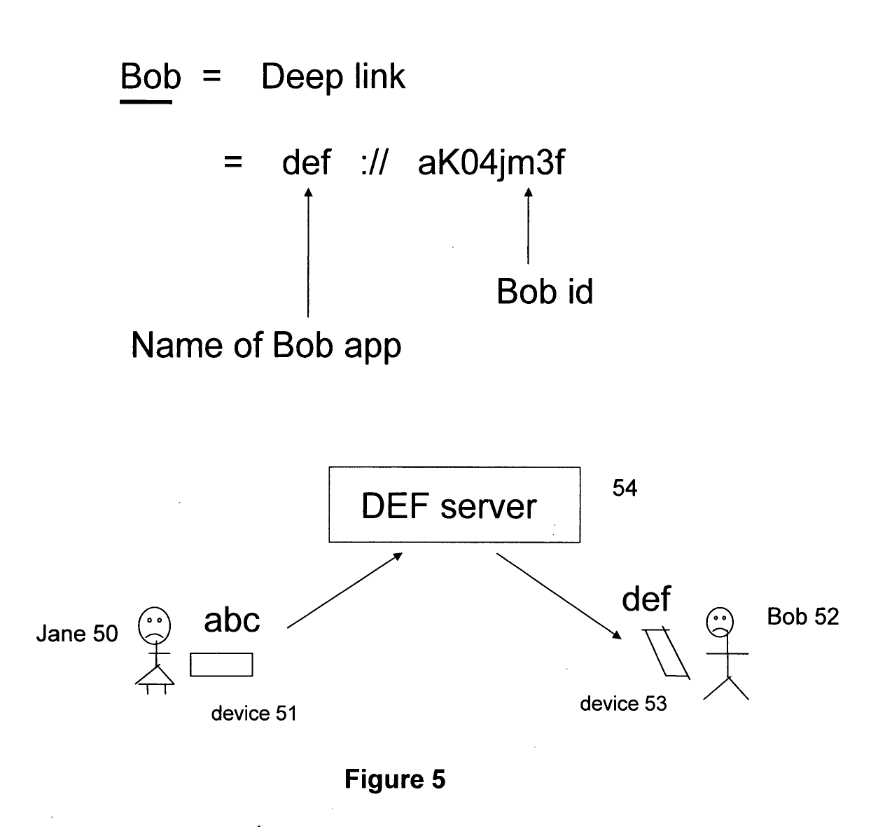

Suppose she picks Bob. One case of what happens next is shown in FIG. 5. When Bob's server sent data about him, it included a deep link. So Jane picking Bob causes an execution of a deep link, just like clicking a link in a web page causes the URL in the link to be activated.

Currently, the format and functionality of a deep link are not standardised, unlike URLs. Different companies have different suggestions about deep links. This submission considers a deep link to have at least 2 parts. One part is a name or identifier of an app. The other part is an identifier of an instance of the app. For the first part, the identifier of the app can be some label sufficient to uniquely identify the app server's domain on the Internet, or a label (=string) that can be used in an app store to find the app. FIG. 5 shows the app name or identifier to be “def”. This is a placeholder. It is separated from the second part by the delimiting characters “://”. These are arbitrary, but in the example are deliberately chosen to be the same as in an URL.

Suppose the def server is listening at green.def.com:9051. Then this might be the identifier before the “://”. Other choices are possible. In the prior art, some efforts at defining a deep link use this URL-like format, where the string before the “://” is sometimes called the “scheme”. Those prior art formats all, to the best of our knowledge at this time of submission, put other strings after “://”, that are not the network address (or an identifier of it) of an app instance. Typically these designate a location within the app. Like a given product page or screen, if we think of the app as a collection of such pages or screens, like a product catalog. Our format in FIG. 5 differs. Our string after the “://” is an identifier of an address of an instance of the app. Though our format also allows for extra parameters.

The basic reason for the different in format between our deep link and the prior art is that the latter focuses on different apps on the same device. Because it is the same device, there is no need to write the address of the device in their deep link. By the prior art focusing on essentially one mobile device for the original app and the invoked app, it led to an approach that inadvertently ignored any need for a network address of the second app.

In FIG. 5, purely for ease of understanding the display, there is extra leading and trailing white space around “://”. In any actual text representation, no such white space would likely be used.

FIG. 5 shows the second part of the deep link as a pseudo-random string. The def server keeps a table that maps this to an instance of app def running on Bob's device. Hence FIG. 5 shows Jane 50 and her device 51 using the deep link to find and make a connection to def server 54. It sends the server Bob's string, whereupon the server connects to an instance of def running on device 53 of Bob 52. Subsequent interactions between Bob and Jane go via def server. Or, the server might send Bob Jane's address, so that his instance can contact her instance directly.

A variant of FIG. 5 is where her device first goes to her app server with the deep link. Her app server uses it to connect to def server. Interactions then go through both servers.

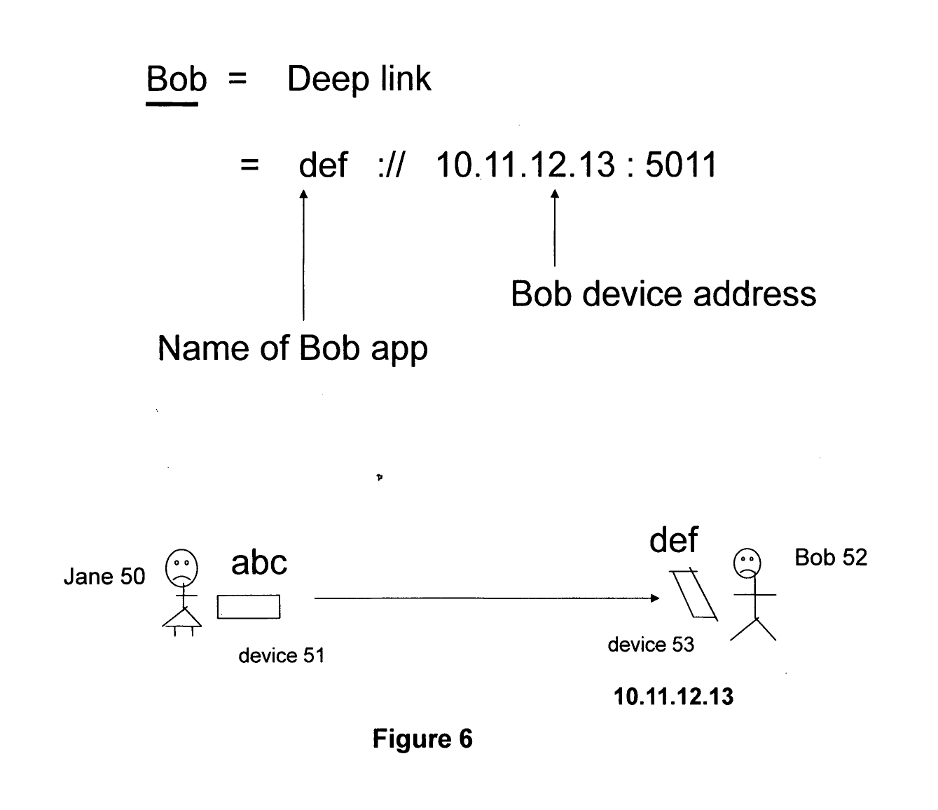

Instead of FIG. 5, the deep link can take different form as in FIG. 6. The deep link as before has the app name “def”. But now the app instance is represented by 10.11.12.13, which is assumed to be the network address of Bob's instance. And a port number 5011. The instance listens at this port for input. When Jane picked Bob in FIG. 4, her abc instance can now communicate with Bob's def instance, without going through the def server (or the abc server).

FIG. 6 uses the network address in Internet Protocol version 4 (IPv4). The expression could also be in IPv6 format.

This “direct” communication between the app instances of abc and def could be done, for example, by each app using a modification of the WebRTC protocol. The latter was meant for real time interaction between 2 web browsers. It can be extended to the uses of this submission. We said “direct” in quotes because the interaction still goes between the various wireless intermediary machines that each mobile device uses. It is not a literal direct line of sight interaction. There is no requirement that the mobile devices are in line of sight. Or, if they were, that they have compatible transmitters and receivers for a line of sight interaction.

One app might use the method of FIG. 5, while another app could use the method of FIG. 6. In general, the results of other users sent to Jane's app in FIG. 4 can have both cases.

It can also be that for a given app and its server, that the server could return some results using the deep link choice of FIG. 5 and some results using FIG. 6. There is no requirement that an app server be restricted to always using only one of FIG. 5 or FIG. 6.

Having said this, the submission suggests that using the deep link choice of FIG. 6 may be preferable for many apps. It could permit a more rapid interaction between different apps, by removing the presence of a server as intermediary.

FIGS. 5 and 6 show a given type of deep link format, with the ability to show an identifier of a person or his device. FIG. 2 showed Jane's app server connecting to other app servers, and they return deep links (and other information).

Because there is no standard deep link format, different servers can use formats advocated by different companies. Hence, when Jane's app shows results like in FIG. 3 and when a given deep link is executed, her app would know the main formats of deep links and how to run a deep link. So FIG. 3 might have Mike's deep link written in the format used by Google App Indexing, while Doris' deep link was written in the format of Twitter App Cards. Even if the current uses of those formats does not permit this, we can imagine straightforward extensions to enable this.

Suppose by either FIG. 5 or 6, Jane's app now starts an interaction with Bob's app. The apps could interact in an initialisation stage, to define the type of later interaction. Perhaps text only, text and audio, audio only or video. This can be done via queries made from one app to the other, via another API.

This choice need not be symmetric. For example, Jane's app might agree to send text to Bob, while it will display text and play audio from Bob. One reason could be the asymmetric bandwidths available to Jane's device. Likewise for Bob. For example, perhaps Jane's downstream bandwidth (from the network to her device) is much greater than her upstream bandwidth (from her device to the network). She might be unable to transmit more than text to Bob, while she could get audio from him.

Another reason could be privacy. Jane might be willing to see some static images of Bob, but will not, at least initially, send him images of her.

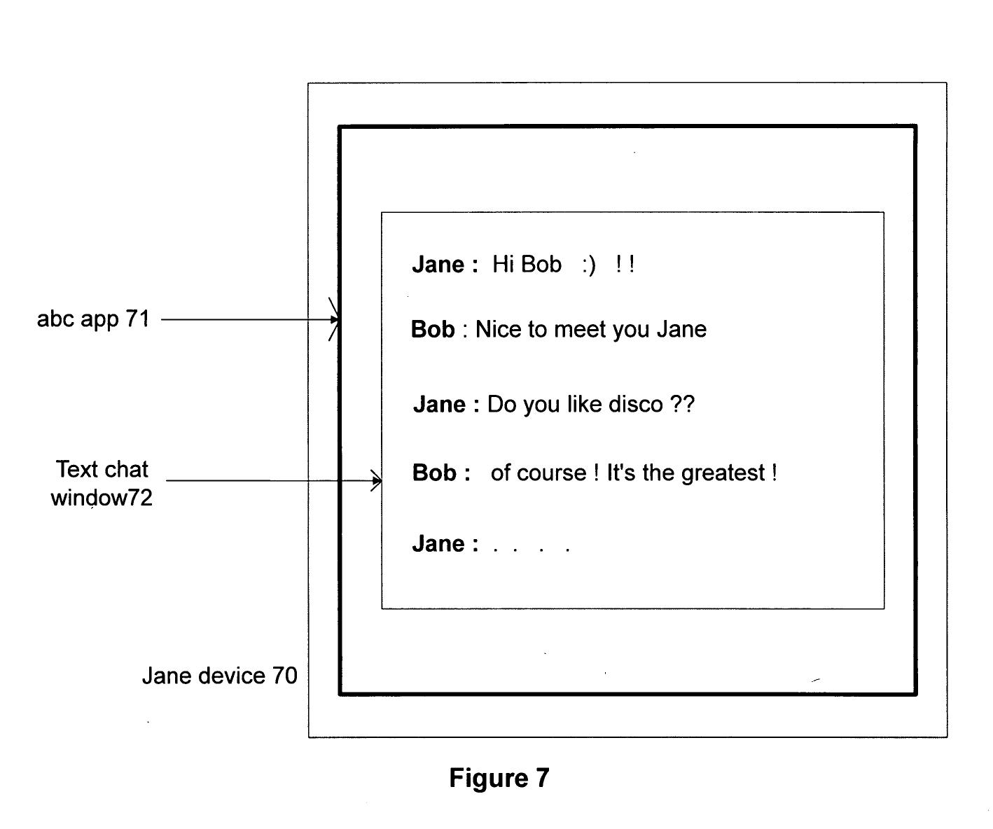

FIG. 7 shows a case of a text window on Jane's device. On Jane device 70 is abc app 71. In this window is a subwindow (or popup window) called Text chat window 72. Inside the latter is the text conversation. Here, Bob on his def instance can be assumed to have a similar window showing the same conversation. Bob might be able to type his text into this chat window. Or he might be able to speak into his device, which runs an Automatic Speech Recogniser (ASR) that converts this to text. The text is written to the chat window and sent to Jane's device.

Because this submission is written as static text and images, we ask the reader to imagine that FIG. 7 can be suitably altered to handle the other cases of audio and video.

The interactions could be turn based or not. Turn based is where when Jane sends some message (text, audio or video), she cannot send another message until she gets a reply from Bob. Non turn based is where she sends some message, and then can send another, before a reply is gotten from Bob.

For any of these cases, when Jane stays within her abc app, during this interaction with the user on the other app, her app has more chance to keep her. During which it can show ads or do other actions to encourage her to keep using it, especially after she ends her interaction with the other person. For example, she might not be interested in meeting with Bob after chatting with him in FIG. 7.

2: Variants;

The app used by Jane might also let her define which other apps (or rather the app servers corresponding to those apps) to query. This can be both explicit and implicit. When she installs her app, or during her initial use, she might be asked for her hobbies or other preferences. Given this, her app server can ask a registry of apps (and their servers) for apps appropriate to her. Then it is these that are asked by her server. This reduces the workload on her server, instead of it having to ask all the servers that have signed up with the registry.

Jane could have the option of explicitly suggesting to her server names of other app servers to query. Likewise, for the list of servers that her server asks, Jane might be able to remove some servers.

As a practical matter, her app server could impose a maximum number of other app servers to ask. If she wants more servers asked, she might have to pay more. This can be a useful revenue stream for her app server.

The previous section discussed how Jane had a mobile device, which uploaded a location. But this did not have to be the current location of the device. This gives rise to another case. Where Jane does not use a mobile device. She might be at a fixed location, working on a personal computer or laptop. She wants to meet others at a different location

Note that when Jane interacts with another person using the method, she does not need to subsequently meet him in person. Also, initially when her app sent her location to another machine, to be used as a basis for finding others nearby, the coordinates could be of another location. Where perhaps she intends to be at some future time.

3: Task Based or Transactional Apps;

Thus far we considered social apps. These are apps whose primary aim is a social interaction between 2 or more persons. Another group of apps might be those of a task based or transactional nature. Imagine perhaps apps designed for rides. Currently such include Uber, Lyft and Sidecar. Another group of apps could be used for finding those available to do manual tasks. This includes TaskRabbit and other related apps. A common problem is that if the user wants to find the “best” (e.g. cheapest, quickest) deal across the apps in a group, she has to download and run each app and compare the results. While the downloading is only once per app, the running of each needs to be done each time she has a task. Far more manual effort.

The method of the earlier sections can be extended to this section. The common feature with earlier is that the parties often have to meet in person.

One different aspect is the likely monetary nature of the transaction. Imagine a ride app. It could use Jane's current location. Jane can input a destination and a maximum price. There might also be other parameters, like a need to travel in minimum time. Or to have a large vehicle because she has much luggage. The data can be uploaded to the app server. It asks the Uber, Lyft, Sidecar and other servers in personal transportation, giving her needs.

Unlike many uses of social apps, one aspect is that her app could be willing to wait some time for results. In part to give others who might be able to handle her task time to be aware of it and bid on it. So another parameter that she might upload (or her app can have a default value here) is a deadline for bids. After the deadline, her server aggregates the results and for example finds the cheapest and second cheapest, and downloads data about these drivers to her app. The bids can be sorted by their amounts, as a default sorting metric.

She picks one. This picking in her app leads to an interaction and a scheduling with the corresponding driver. This can be where the other sites send to her server deep links pointing to instances of the other apps run by their drivers. Her app lets her make a direct interaction with her chosen driver via the deep link to him.

4: Server Registry;

FIG. 3 depicted abc server knowing about the def, jkl and xyz servers that satisfy an API for querying about their users. Left unsaid was how abc server would know these other servers. One answer is that each of the other servers could at some earlier times submit information about themselves, including that they satisfy the API, to abc server. The latter might have some steps, including possibly manual steps, to verify that the servers are reputable. So that abc server will send its queries as in FIG. 3.

However, if there are n social apps, then the method of the previous paragraph implies an n*(n−1)/2 or n**2 scaling, which is awkward. Another way can be a registry service, perhaps run as a Web Service. The registry could accept submissions from various app servers, which would then credential them. It saves an app, especially a new one, from having to validate n other apps.

Consider abc server working with the registry, in the context of Jane's abc instance. Suppose the registry has many app servers, for all types of apps. It is impractical that every time Jane uses abc and wants to find others that her server asks the registry for all those app servers. One simplification can be if her server knows her interests. That perhaps by asking her, she told it at some earlier time that she was interested in dating, music and a few other types of social apps. The abc server can ask the registry for app servers in those areas, and cache the results. It can do this not just for Jane, but across all its users, to reduce the number of requests to the registry.

Periodically, it can re-ask the registry for apps in those areas. Because new apps have been added to the registry and may be some apps have been deleted.

Another thing the abc server can do is ask the servers it got from the registry for any geographic preference for their users. So when Jane sends her location to the server, it can avoid asking servers that likely have few users near her. This will not always be true, but it is a pragmatic approach to reducing the size of the problem.

The registry functions somewhat like an App Store. The latter is typically only for one mobile device platform, like Android or iPhone/iPad. The registry would curate apps (and their servers) for all major device platforms.

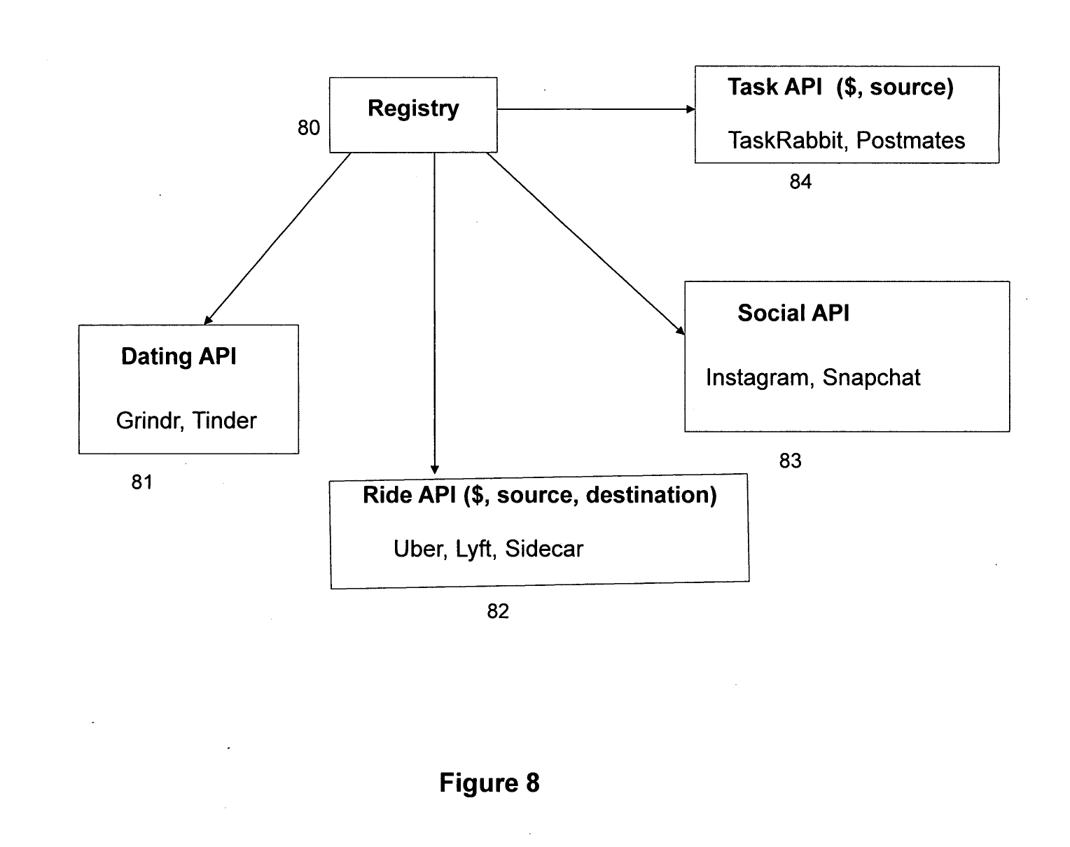

FIG. 8 depicts Registry 80 having several subregistries, each with its own API. For example, there is the Dating API 81, Ride API 82, Social API 83 and Task API 84. Each group shows several actual apps in that category. An app can be in several groups.

The Ride API 82 shows in its title several parameters that are likely to be key to that group—the dollar sign indicates a monetary interaction. The source and destination are intrinsic to the ride that the user wants. For the Task API 84, the parameters are the dollar sign for a monetary interaction and a source. The difference between the 2 groups could be that for a task, there might be at only one location, defined as the source. Of course, some tasks might span several locations. The parameters given as examples for these 2 groups do not preclude the groups from having more parameters to define an interaction.

FIG. 8 depicts Registry 80 as having only one level of depth. Another way might be for an API or group structure to be several levels deep. For example, the Task and Ride API s might be grouped under a common API, that then descends into these 2 API s.

Each group or subregistry might be run by a different organisation.

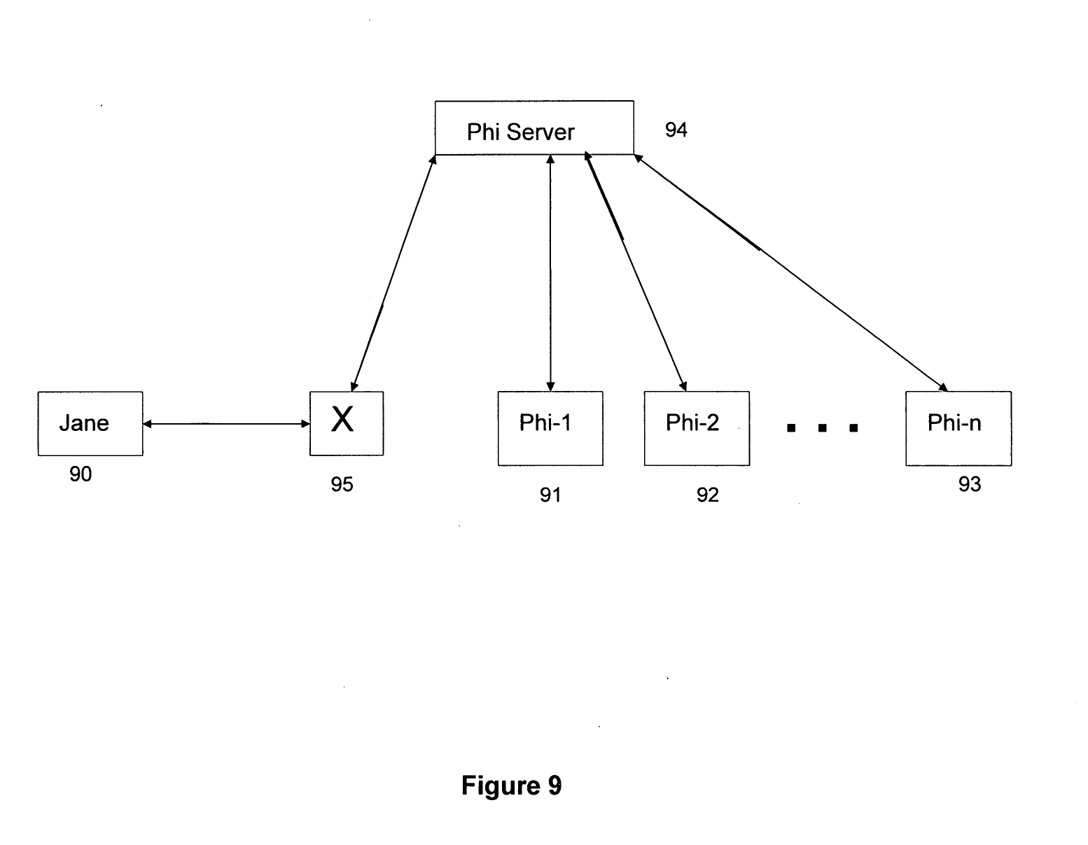

Thus far, we discussed how an app and its server could be altered to be used in the methods of the submission. But suppose an app and its server is not altered. How could the submission be done with the app? See FIG. 9. Jane and her device are item 90. Item 91 is an instance Phi-1 of Phi app. Item 92 is another instance Phi-2 of the app. And so on to Phi-n as item 93. The instances can typically be running on mobile devices. Each instance talks to the Phi server 94. The latter does not use this submission. We assume that each instance can upload its location to Phi server, and wants the locations of other nearby instances.

There is a program X, item 95, running at some address on the network. Typically, this would not be on a mobile device. Being at a fixed location, it could have a stable domain name, unlike the app instances on mobile devices, which might have temporary network addresses. X acts as a proxy.

When Jane accesses X, it pretends to be Phi server. So if she is looking for a social app, and Phi is a social app, her device asks X, giving her location, for example. X takes the location and pretends to be a Phi instance, uploading this to Phi server. The data about other users of Phi are received by X, which forwards to Jane. X acts as a proxy or intermediary. X might be written and owned by an organisation different from the owner of Phi server.

5: Deep Link for Installing an App;

5.1: Installing an App Before Interaction;

From FIG. 4, when Jane got a window or screen inside her abc app that showed other people nearby, she picked Bob. Her app went via one of FIG. 5 or 6 to opening an internal interaction window in FIG. 7. But there is an alternative. When Jane clicks on the link “Bob” in FIG. 4, her app might offer an alternative where the app that Bob uses is downloaded onto her device, if it does not already exist. The def app on her device is started, and loaded with Bob's id from the deep link. So her def instance can interact with Bob's def instance. Either by going through the def server or by directly talking to the address of Bob's instance.

In submissions 10, 11 and 12, we described ways that her abc instance can install and run def. Essentially it can pass the deep link to another program on Jane's device, which we called a Deep Linker. The latter has functionality that could be used by various apps to install and run another app. One variant is where the Deep Linker is part of the mobile operating system. Another variant is where the Deep Linker is an app itself, written by a firm independent of the firms that wrote other apps on her device.

The above steps take her out of her abc instance. Why would abc let her do this? One reason might be that the deep link which came from either Bob's def instance or the def server, has an argument x, which can be a pseudorandom bit sequence. Jane's abc extracts x and adds a datum y that identifies one or more of Jane's abc instance, Jane's device, Jane or the abc server. The doublet (x,y) can be sent to the abc server, which can later send it to the def server. A variant is where y is added by abc server, instead of being made by Jane's instance. The def server credits the abc server for installing def on Jane's machine. In turn, the abc server might pass some of this credit to Jane.

To try to prevent fraud some precautions can be taken. When def server makes x, it allows only one use. A rogue abc server cannot submit several copies of x and get credit for each. (Click fraud). Another step is that the crediting of abc server might happen only after def server detects the install of def on Jane's machine and some measure of subsequent use. The latter assumes the typical case where an app communicates intermittently with its server.

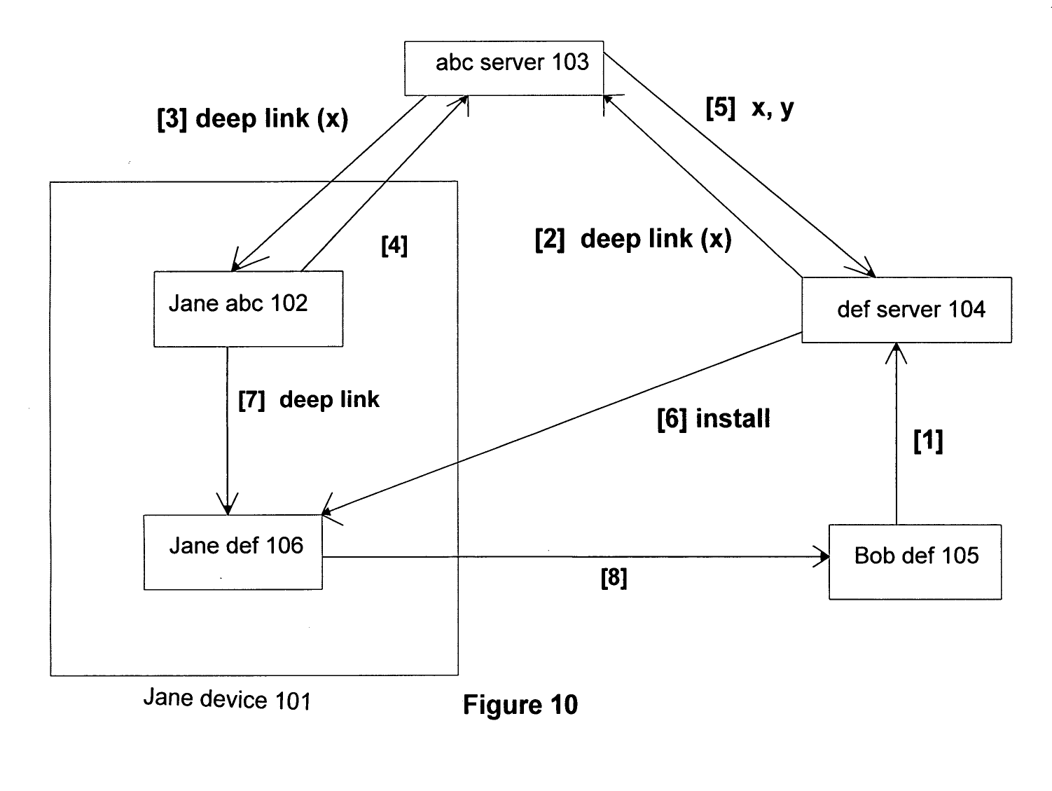

FIG. 10 shows an example of the above. There is Jane device 101, containing the app instance Jane abc 102. This talks to abc server 103. Meanwhile the app instance Bob def 105 talks to its server, def server 104. In step [1], Bob def 105 uploads his coordinates and perhaps other data to def server 104.

The def server makes x and a deep link and embeds x in it as an extra argument, or, equivalently, appends it outside the deep link, but in a data structure. Step [2] shows the data structure or deep link being sent to abc server 103. This sends the deep link in step [3] to Jane abc 102. Which displays it and results from other servers, as per FIG. 4.

If Jane picks Bob and his link, then step [4] shows the choice being uploaded to abc server 103. Step [5] transports (x,y) to def server 104. The y can be made either by Jane abc 102 or by abc server 103.

Step [6] has the deep link being executed, to install Jane def 106 on Jane device 101. Here, abc server might not be involved. For clarity, no link is shown between Jane device 101 and def server 104 in this step. Once the install is done, step [7] sends the deep link to the instance of def when it starts up. Step [8] has Jane def 106 use the deep link to talk to Bob def 105.

Thus abc is compensated for helping install def on a machine.

Suppose that def was already on Jane's device when she picked Bob's link. Her abc app could let her start a def instance, without having to do an install of def. The earlier steps can be mostly still done. The abc server gets some credit from the def server (perhaps less than in the previous case) for running an instance of def, that takes user attention away from abc.

FIG. 4 showed 3 users in Jane's abc app, where each user's name was clickable, with the effect described above. And where clicking a name would lead to installing or running a different app—an instance of the one used by that person. But Jane's app does not need to make each name clickable. For example, it or its server might require some prior arrangement with those other app servers. Like agreeing to a compensation according to the steps above.

Another case is that the deep link associated with a user in the list in FIG. 4 might be checked against a blacklist, done by abc or its server. A useful step because of the potential of bad sites being met when installing or running of another app.

FIG. 4 depicted only one deep link per person. In general, there could be several. For example, see image 42. This might also be clickable, with a deep link activated when done so. More generally, data about a person could be written in for example HTML5 (or some other language that enables links), where some links might be deep links. If there are several deep links per person, they do not have to be the same. How they differ can vary.

One case is where some deep links refer to different apps. Another is that the deep links all use the same app, but have addresses of different instances. This lets the entry for one person in FIG. 4 actually let Jane contact one or several users. Or one deep link might be to a program with which Jane can interact, rather than a person.

Another is that the app names and instance address are the same, but extra parameters in the links differ.

Suppose FIG. 4 shows several persons, and there are several deep links available for Jane to pick. Her app could preferentially display some deep links. These might be for apps already installed on her device. If she picks such a link, she can go faster into the interaction, skipping any install. Also, she is more likely to be familiar with the app. Another criterion is for apps that are popular. Another criterion is reputation of the apps. There could be a service external to her device, and maybe also external to her app server, that rates apps. Well rated apps referred to in the deep links of her FIG. 4 can be emphasised by her abc app.

5.2: Installing an App After Interaction;

The previous subsection discussed the case of Jane installing and running Bob's app on her device before interaction. The opposite is also possible, after they being interacting. See FIG. 7. Suppose Jane uses her abc app to interact with Bob on his def app. Her app can let her try to convert Bob to installing an instance of her abc app, to continue their interaction via strictly 2 instances of that app. Her app can easily make a deep link, like “abc://40.41.42.43”. Here the “abc” is the name or identifier of her abc app. The raw network address (possibly with a port number) is her device address.

The deep link is just text. So if Jane is using a text window to talk to Bob, it is trivial for the app, perhaps with her consent, to write the deep link in a text string that is sent to Bob. This text string might be appended to actual text that Jane wrote. Or it might be a standalone text message. The abc app might automatically insert this, without asking her.

When Bob gets the string, he can use it to install the abc app if it is not already on his device. And then to run it with the deep link, so that it communicates with Jane's abc instance. It is assumed that her instance is listening on a given port for such a message from Bob.

The installation steps Bob has to do can vary. Broadly, he can copy the deep link from the message from Jane. He starts a program on his device like the Deep Linker of submissions 10, 11 and 12, and gives it the deep link. The program does other steps of the previous paragraph. This assumed that Jane and Bob were both using a text window on their apps.

Suppose Bob gets audio from Jane, while he might be sending her audio and text. Jane's app can encode the deep link as audio. Perhaps by using the chirp method of Bergel (see our submission 7 and US Patent Application “Data communication system”, 20120084131). By whatever audio encoding means, this assumes Bob has the necessary functionality on his device to decode the audio into the deep link.

The decoding has an advantage over common audio decoding methods, including the Bergel approach. Those use a microphone to get sound waves from the air. These are converted to analog electric signals, which are then run through an analog to digital converter. Then various methods of digital electronics are used downstream. But in the case of Bob's device, it gets the audio already digitised. A simplification. The reader can appreciate that it is straightforward to modify existing decoding methods to take advantage of this.

Suppose Jane's app sends Bob video that appears in his app. Her app can insert a deep link. One way is as text that overlays the rest of the video. His device can run Optical Character Recognition to extract the text. Another way is for her app to make a barcode (like a QR or Data Matrix code) that encodes the deep link. His device can run a barcode decoder to recognise and extract the deep link.

For OCR and barcode decoding, such methods for mobile devices typically use a camera on the device to scan an external image and then decode. The present context does not use any camera that might be part of Bob's device. Instead, the image is already in his device, since it is displaying the image on its screen. The reader can appreciate that the present context is simpler in terms of hardware. It is straightforward to modify existing programs that do decoding from a camera. Another advantage is that there is less manual involvement by Bob. Using a camera requires him to move his device until the barcode comes within full view of the camera, and then to click to take a photo. But with the barcode inserted at a fixed location in the image, as an overlayer, it is far simpler for the decoding software to find the barcode.

Another case is to use the functionality of the window in the app, which shows the video. This might be selectable by Bob, just like an image in a web page in a browser might be. So when Bob picks this, it activates the deep link, to start an install process. But there is a qualitative difference between this and the other methods where the deep link is embedded in the video as a barcode or text. It is trivial for Bob's app not to make the video window pickable. Whereas there is more work for the app to find a barcode in the video. More to the point, once his app finds the barcode, it can remove it. But there is nothing under the barcode in the video. So the app has to replace the barcode with something else, that can be distracting or lower Bob's user experience. Though granted, when the barcode appears in the video, covering up whatever was in the original message, that can also be considered to lower the viewing experience of the video.

All the ways that her app can insert a deep link in the messages from her are means for the app to promote and propagate itself. Useful for the app and its server. Especially if there might be no means for Bob to avoid seeing or hearing these links.

Her server might let her suppress the links, perhaps on payment of a fee for this premium feature.

This subsection discussed the case when Bob might install Jane's app after they have already started interacting via their own (different) apps. This is symmetric. We could have equivalently described Jane installing Bob's app. But the previous subsection was inherently asymmetric. Jane gets Bob's deep link in her own app, before they begin interacting.

There can be a difference between the methods we discussed of Bob installing Jane's app and the earlier case of Jane installing Bob's app. The latter involved active participation of abc, which likely means the def server has to compensate the abc server. The former does not need the abc server to pay the def server.

6: Transient Deep Link;

Consider again FIG. 6. It shows the deep link, with an explicit address of an app instance after the “://”. If the address is in IPv4 format, as shown in the figure, consider how this can arise. The address is the address of Bob's device, which we can take to be mobile. He connects to the Internet in typically one of two ways—via a phone carrier or using a WiFi hotspot. For the latter, sometimes there might be other wireless protocols, like WiMax.

The phone carrier or hot spot might temporarily assign his device an IP address, out of a fixed set of IP addresses that it has for this purpose.

The problem is that Bob can move. If he uses a hot spot and moves out of range, and then reconnects using another hot spot or carrier, he will likely be assigned a different address. If his original temporary address was via his phone carrier, this address might be good over a large region, like a city. Because the carrier might has a pool of addresses for this city, and a different pool for another city.

If Bob's device address is in IPv6 format, this might be a permanent address. One of the mooted advantages of IPv6 over IPv4 is the chance of allocating permanent addresses to mobile devices. But even here, it is not guaranteed that his device has a permanent address.

So if Bob moves and gets a different address, the previous deep link made by his app is no longer valid. We call this phenomenon a “transient deep link”. This is different than the term in the prior art “deferred deep link”. The latter is when the string before the “://” refers to an app which is not on the user's device. So the app must somehow first be installed. Then the rest of the deep link is sent to the running instance of the app; typically to put the app on a specific product page. Hence the full deep link is “deferred” until after installation. All this happens on one mobile device in the prior art. It does not refer to the problem of 2 mobile devices with different apps trying to contact each other.

Fundamentally, the prior art does not have the issue of an outdated address, simply because it does not explicitly put an address into its deep link. Whereas because our instances of deep links inherently refer to other (mobile) devices, the transient nature can arise.

How to handle the problem? One answer is to use FIG. 5. Instead of putting an explicit address in the deep link, an identifier of the app instance is used. The first user, Jane, has to have her app talk to Bob's app server, which knows Bob's current device address. This works, but involves first going through the app server.

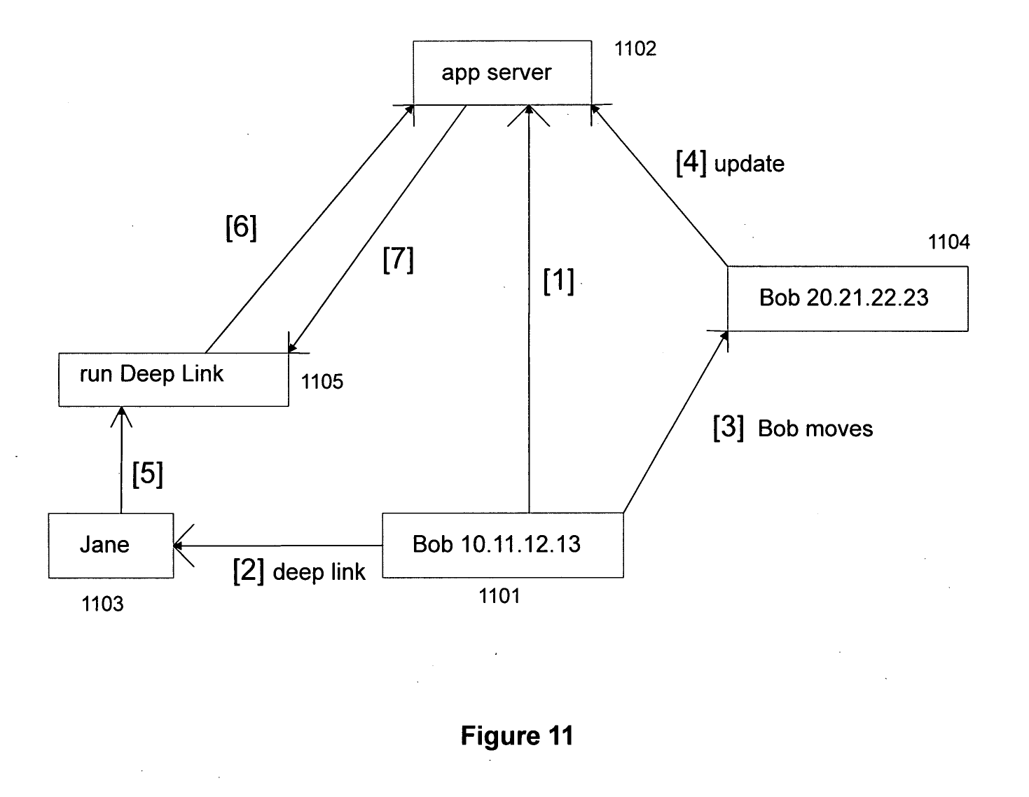

The other answer is as follows. See FIG. 11. Bob 1101 runs his app def as in FIG. 6. Step [1] has his app talk to the app server 1102. The server records his device address 10.11.12.13 and associates this with some identifier of one or more of his app instance, his device (e.g. its MAC id) or him (like his email address, public key or biometric). In step [2], the deep link of FIG. 6 is received by Jane 1103 in some manner. Here the item Jane 1103 refers to Jane and her device. Perhaps the deep link is sent to a web page and Jane reads the page and picks the deep link. Here, Jane and Bob might be in different places. Or if Jane and Bob know each other, and he sends her email with his deep link. Or Bob sent that email to a third party person, which then forwarded it to Jane.

In step [3], Bob moves and gets a new address 20.21.22.23 in item 1104. His app updates the server in step [4] with this. This can simply be done via a periodic check in from the app to the server. The server inspects the source address of the Internet package from Bob and sees that his address has changed. The server has a table, associated with the permanent id. This table keeps a list of his app addresses. It updates with the current address 20.21.22.23, and its status in the table is defined as current. The previous address is kept, and its status is changed to expired. There can be provision that expired addresses are deleted after some maximum time. This is different from when Bob stays active at an address. If he does not change addresses, then that address might be stored indefinitely at the server as the current address.

The server can have another table, where all the addresses, current or expired, across all users of the app, are kept. The addresses here can act as pointers to instances of the former table specific to each user. Readers familiar with databases will understand that the table structures are straightforward to implement.

A variant of the previous paragraph is where before or during step [3], Bob closes his app or may be even shuts down his device. In his new location, he starts a new instance of the app, which talks to its server.

In step [5], Jane runs the deep link as item 1105. Maybe if the deep link was in an email or web page, by the time she read the email or page and picked the link, Bob had already moved.

There are several possibilities about what happens. First, her device finds that nothing replies at the deep link address 10.11.12.13. This can arise if when Bob now longer uses the address in the deep link, then the machine that hands these out on a temporary basis to mobile devices has not assigned the address to another device.

Second, the address is now in use by another device. In general, the apps on this device will not be listening on port 5011 in FIG. 6 that the def instance would be.

But suppose the device has a program listening on that port. The third case is that this program will likely not be the def app. When Jane's app tries to engage that program, an error will occur, because the interaction protocol is not correct according to her app.

The fourth case is that another user is running another instance of def, that is listening on port 5011 at the time when Jane's device with its def instance is trying to connect to that port. So a correct def connection is made, but to a different user. Coincidence. Unless the app is wildly popular, this case may be the most unlikely.

The rest of this section deals with the first 3 cases. The common feature is that Jane's device app instance does not get a correct interaction (if any), so her app can have logic (perhaps running in its own thread) to detect this. Her device asks the def server in step [6]. Note that the def server is defined in the deep link as in FIG. 6. Her device sends the now invalid address 10.11.12.13 to the server. The server finds that the table that the address is in, and sees that the most recent address in the table is 20.21.22.23. The server replies in step [7] with the latter address. Jane's device makes a new deep link, replacing the old 10.11.12.13 with 20.21.22.23 and now successfully talks to Bob's app. This last is an implicit step [8] that is not shown in FIG. 11 for clarity.

Note that item 1105 “run Deep Link” could have been merged into Jane 1103. With step [5] omitted and step [6] becoming step [5] and step [7] becoming step [6]. But again for clarity, item 1105 and step [5] were explicitly shown.

This ability to handle a transient deep link has another useful feature. Suppose Bob wants to make a deep link to his app instance, where the deep link might have instructions to run it in 24 hours time. A scheduling constraint. Bob's app can make a current deep link, using his device's current address. He might now know where he will be in 24 hours, but he does not know what his device address will be at that time. More generally, he does not even need to know his future location. This method lets him publicise his deep link and let it be used even when apparently expired.

The method of this section improves the usability of deep links.

7: Forwarding a Deep Link;

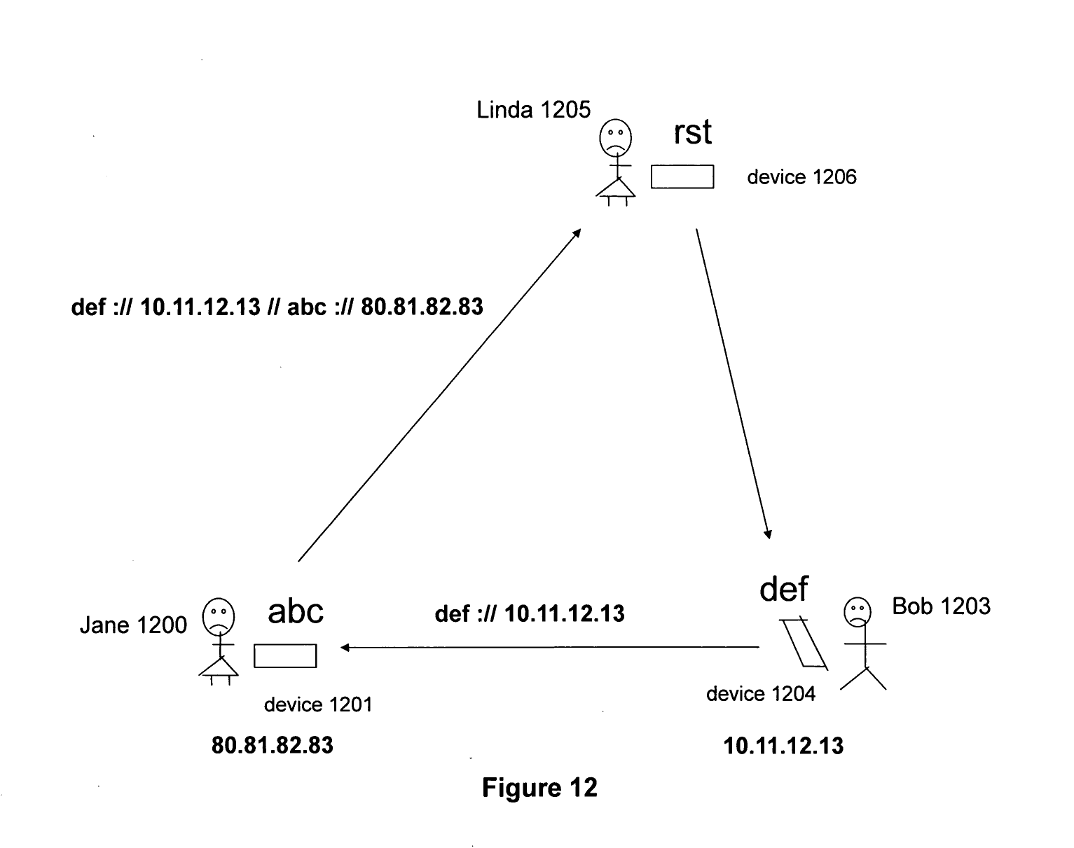

The reader is familiar with the forwarding of an email. This section discusses the forwarding of a deep link, which has different properties from email forwarding. See FIG. 12. There is Jane 1200 with her device 1201, and Bob 1203 with his device 1204. The network address of his device is 10.11.12.13, while the network address of Jane's device is 80.81.82.83. Bob is running app def on his device and Jane is running app abc on her device. Bob's app makes the deep link, which we take to be def://10.11.12.13. Jane gets this by various means, discussed earlier. These can include her reading it on a web page, at a website where Bob posted the deep link. Or if he somehow knows her, he might have sent he directly an electronic message (e.g. email or text message) with the deep link.

Jane forwards the deep link to Linda 1205, who has device 1206. We suppose here that Jane did the forwarding from within Jane's abc app. This forwarding can be independent of whether Jane is using her abc app to interact with Bob's def app in the manner of earlier sections. Perhaps Jane was considering interacting with Bob, but decided against it. However, Jane might know Linda, and thinks Linda might want to interact with Bob, so in Jane's abc app, she picks an option to forward the deep link. This option could have choices for what else, if any, to add to or alter the deep link from Bob. For example, Jane's app name or identifier could be appended. Perhaps also Jane's device network address. If both choices are made, this amounts to appending a deep link of Jane's app and address to the Bob deep link. This is shown in FIG. 12, as the label on the arrow from Jane to Linda.

Jane's app could have an option where she types in the email address or another electronic address of the recipient. So if she knows Linda, she can type in Linda's address here. The deep link is sent in the message to that address. Or Jane might post the deep link on her Facebook page as a “like”, or she may have posted it on other social media, recommending that others click on it or copy it and run it on their devices.

The format of this deep link is arbitrary. An example is depicted, where Jane's deep link is separated from the original Bob deep link by the delimiter “//”. As in earlier figures, there is white space in FIG. 12 in the deep links purely to enhance readability. Also for clarity, any port numbers specific to the def and abc apps are omitted from the compound deep link.

Linda uses her rst app to load the compound deep link she got from Jane. Her rst app then interacts with Bob's def app. The rst app can extract the original Bob deep link, in order to interact with Bob. There is no ambiguity to the parsing routine in rst, because it can find the first occurrence of “://” and then the delimiter “//” to isolate the original deep link.

Since Linda's app can also extract the deep link of Jane's app, in Linda's interaction with Bob she can send a copy to Jane's app. This is subject to various display limitations of Linda and Jane's apps and of the bandwidth limitations of their devices. In the simplest case, where Linda and Bob interact, and Linda's rst has a text window, showing text sent between them, then Jane might get a copy of this text window. Where Jane's copy can periodically update as it gets new data from Linda's app.

There might be restrictions that Linda imposes on what she sends Jane. Linda might only send what Bob sends to her. Or she might only send what she sends to Bob. Or, and this could be the preferred case, Linda sends full duplex.

This example also shows that in general, Bob, Jane and Linda can all run different apps.

Before Jane forwarded a deep link to Linda, Linda might have sent Jane a deep link referring to Linda running her rst app instance. Then when Jane got Bob's deep link, her app knows where to send this (or an altered copy) to.

The deep link made by Jane can also be signed by her, using her private key (assuming she has one). The signature can be appended to the deep link before it is sent to Linda. This lets Linda or anyone else who gets the deep link verify that Jane sent it. The signature can be of just Bob's original deep link or of that and Jane's app identifier and network address.

The method of Jane appending her deep link increases the length of the resulting deep link, compared to Bob's original deep link. This can be extended. Linda in turn could forward the deep link, where her app appends an identifier of Linda's app and network address. Just like URLs have a maximum length, so too might deep links, to impose a practical limit.

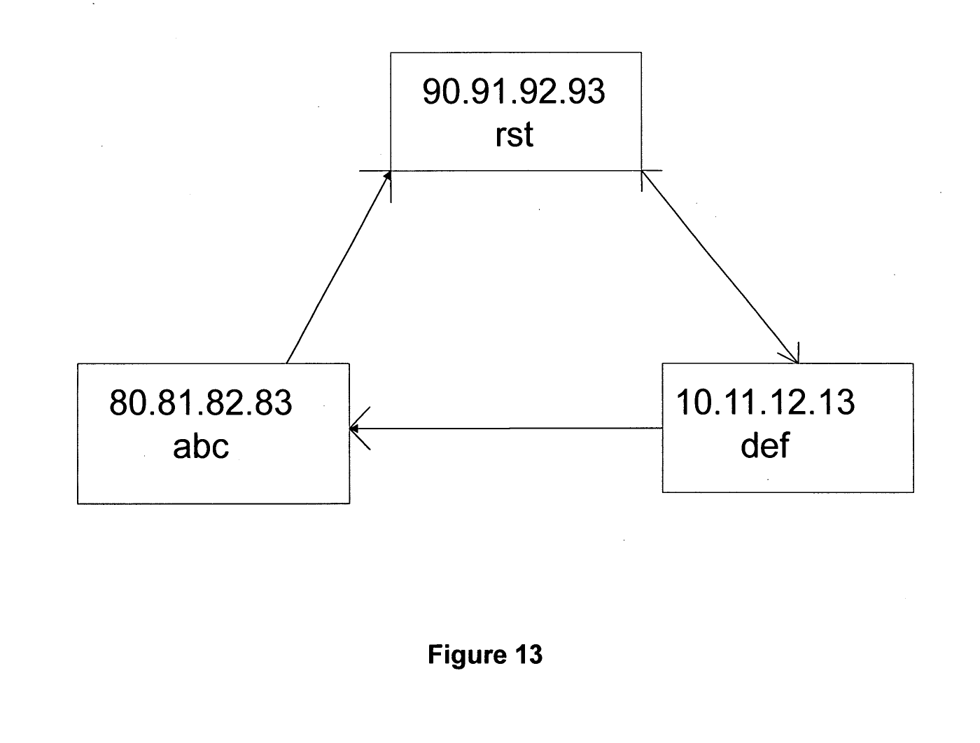

The use of amended (appended) deep links can lead to the drawing of a social network graph. In the simple example above, we get a social graph of 3 nodes. See FIG. 13. It shows the addresses of the 3 users or devices. (Where Linda's address is taken to be 90.91.92.93.) Bob can make this graph if he gets a copy of the deep link that Linda got, which she used to interact with him. And if she also appended her deep link, as Jane did. If she did not, the information in her node can still get gotten by Bob. He gets her address from her messages to him. And during the interaction between his app and hers, he likely can also get an identifier (rst) of her app.

FIG. 13 also depicts directionality in several of the edges. From Bob to Jane is a directed edge. Ditto for from Jane to Linda. While the edge between Linda and Bob is bidirectional, because they interact significantly. It might be objected that the edge between Jane and Linda should also be bidirectional if they also interact, by for example Linda sending Jane copies of her interaction with Bob. But Bob does not necessarily know this, based only on the deep link he got from Linda.

Note also that the deep link he gets from Linda tells him about Jane. Remember that he might not know Jane. The deep link she got from him could be via a third party, like him posting it on a website that she went to.

The forwarding of a deep link with information appended to it, lets a third party amass a social network graph. Of course, the example of FIG. 13 with only 3 users is trivial. However if this can be scaled to many more users, then the value of this can be important in letting that third party understand better the interests of users. In this example, if Bob forwards the deep link he got to that third party, he might be compensated in some manner. Essentially he is forwarding the graph of FIG. 13. The third party could be an existing social network or it could be a search engine.

8: Rating a Deep Link;

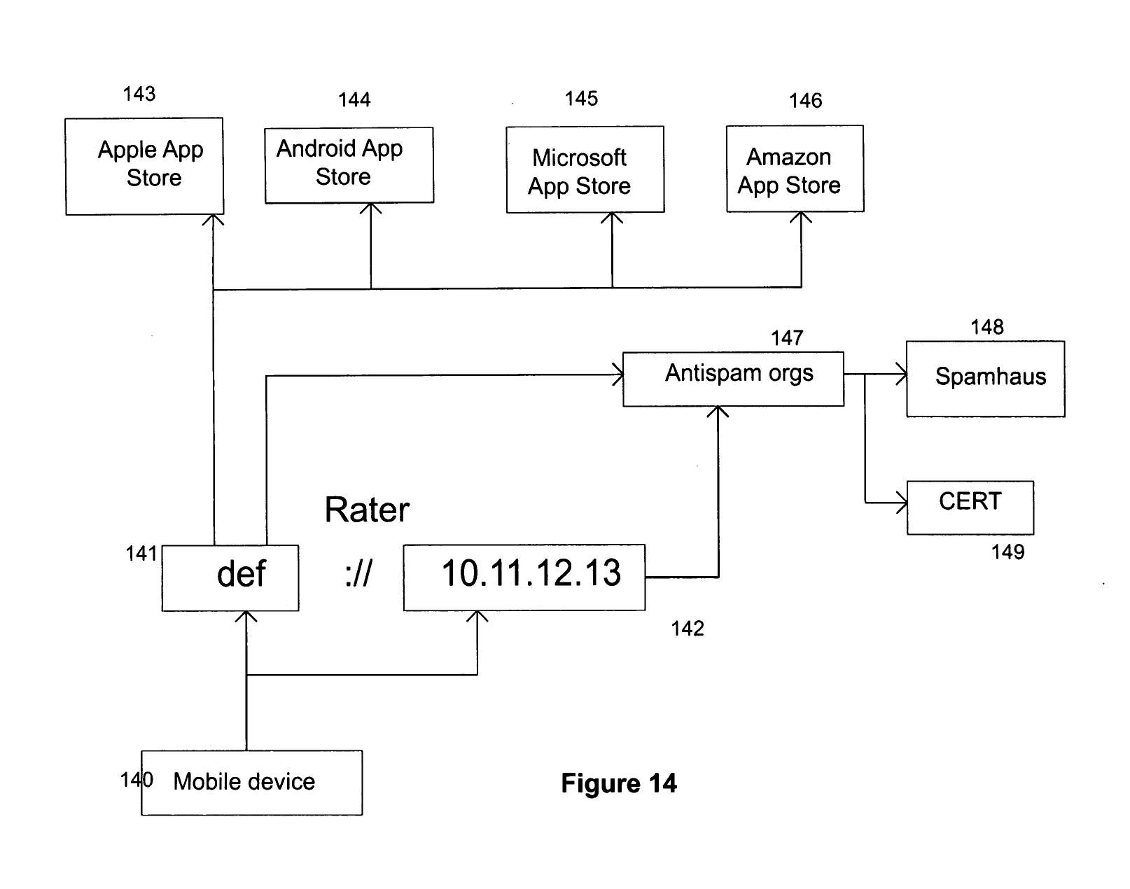

We now turn to the topic of rating a deep link. Consider the deep link of Bob in FIG. 6, where his device network address is used. See FIG. 14. Item 140 is a mobile device. It gets a deep link. Item 141 is the app identifier part of the deep link. Item 142 is his network address. For simplicity, we omit discussion of the port number in FIG. 6.

If we rate a deep link, this can be made of a rating of the app and a rating of the address of an instance of the app. This assumes that the deep link uses an instance address.

Rating=(app rating, instance address rating)

Imagine that a Rater exists to do both. It can exist as a program on the mobile device in conjunction with a website. Below we describe the functionality of the Rater. This can be done in some fashion between the part of the Rater on the mobile device (the local Rater) and the Rater website. There might be no local Rater. For example, an app that gets a deep link might send it across the network to the Rater website, along with any related data. The Rater returns some results. The network Rater functions as a Web Service, effectively.

The Rater is called by a program on Jane's device, that has a deep link. The program might be an app. Or the app might have sent the deep link to the Deep Linker on her device, which then sends it to the Rater. A convenient and preferred place on Jane's device to call the Rater could be the Deep Linker. This would be a common program used by several apps to run a deep link. Hence putting in a test of the deep link here is a refactoring away from the apps.

The arrow from Item 140 to items 141 and 142 can be supposed to be the mobile device uploading the deep link to the Rater. Items 141 and 142 can be considered a deep link gotten by the Rater.

To rate the app, the Rater takes the app identifier and asks various app stores. Item 143 is the Apple App Store. Item 144 is the Android App Store. Item 145 is the Microsoft App Store. Item 146 is the Amazon App Store. Note that the Apple, Android and Microsoft stores are for the mobile devices that run the operating systems associated with those stores. In contrast, the Amazon store can serve apps that are for Apple and Android devices (and possibly also Microsoft Phones). There could be other app stores not depicted in FIG. 14, like perhaps for Blackberry, or for other mobile devices of the future, using other hardware and operating systems.

The different app stores have different identifiers for what is essentially the same app, in general. There can be logic outside the Rater and called by it, that takes the app identifier and maps it to the corresponding identifiers for each app store (if those versions of the app exist). Submission 11 described this functionality. It is analogous to how the Domain Name System maps from a domain name to an Internet address, using a system (hierarchy) of DNS servers. Submission 11 described how a Deep Linker on a mobile device can call outside servers on the network, to find the versions of an app for different platforms.

The app stores act as a credentialing mechanism. A company that makes an app submits it to an app store, which then runs some tests on it to check for malware etc. If the app passes the tests, then it is available on the app store. So if the Rater finds that app def is in an app store, this can be a positive sign.

An app might have versions that run on different platforms. Thus if app def is found in the app stores for Apple and Android, this might be an extra positive sign or weight. It says that two authoritative app stores have accepted the app.

There is no requirement that the Rater ask all or most of the app stores. If the app identifier just maps to a given platform, say Android, then the Rater might only ask the Android app store. However, a preferred implementation is to ask as many app stores as practical.

The app rating can be a scalar (=single number) or a vector (=set of numbers). For example, vector rating=(Apple rating, Android rating, Microsoft rating, Amazon rating, . . . )

The individual store ratings might be written as exactly those given in the stores. Or they could be rescaled to, for example, a range of 1 to 5 if they are not already in this range. Where 1=lowest rating and 5=highest rating.

The scalar rating could be an average of the numbers in the vector rating.

Also, an app store might let users review an app. The reviews assigned by the users and possibly a parsing of their comments can be used by the Rater in finding a rating for the app, in the context of this submission. For example, any reviews and comments for an app in an app store typically only pertain to a version of the app for a given hardware platform. In contrast, the Rater might or should take a broader view, to find the reviews and remarks for all versions of the app.

The app store rating and reviews might be found by screen scraping the web pages of the store, if the store has web pages about its apps. Or the Rater could get the data by emulating a mobile app that searches the store, perhaps if the store has an API to facilitate this.

The reviews can also be used in computing a scalar rating. For example, instead of using a simple average of all the store ratings, a store rating might be normalised by the number of reviews of the app in the store.

For convenience, the Rater might present a scalar app rating to the user. She can click on this to open out more information, like the individual ratings assigned by the app stores. At the GUI level in the mobile device, this is a simple implementation.

The identifier of the app could point to the app server run by the company that owns the app. The company might prefer that users download directly from its servers, so that it does not have to pay a fee to an app store. In this case, the reputation of the company's domain can be assessed. The Rater can optionally contact various antispam organisations, depicted as item 147, with the app identifier in item 141. These might include SpamHaus, item 148, and CERT, item 149. The latter stood for Computer Emergency Response Team. There are various CERTs in the world. They check for malware like viruses, as well as phishing attacks. Item 149 represents all of the CERTs. Item 147 which is labelled “Antispam orgs” is meant to encompass both antispam and antimalware groups. Of course, there could be more groups than just Spamhaus and CERT that are used by the Rater.

As with the app stores, if there are several ratings by antispam groups, a single rating could be computed and shown. The user can open this out to see the underlying ratings from each group.

If the app can be downloaded by both its app server and by various app stores, then the various ratings of both types can be shown. Though by default only one or two summary ratings might first appear.

Now consider item 142. The address of an instance of the app. The Rater can feed this to the antispam organisations, much as it did for the app identifier. If the address is a raw Internet address, there are known antispam techniques that look at the network neighbourhood of the address. If the vicinity has other addresses that have been detected (by whatever means) to be associated with spammers or malware, this can lower the rating of the app instance address.

If the address is a domain name or an IPv6 address that is stable, then the antispam groups might be asked about this domain or address.

The Rater can cache various results before it downloads these to a user. Later, if other users ask about an app, the Rater can check first in its local memory to see if it already has results. Saving it several network queries to the other entities and letting it reply faster to the end user. Caching lets it scale to higher user loads.

As a matter of convenience, if the Rater intends to submit both the app identifier and the instance address to item 147, it can do so in one message, instead of two messages. With the understanding that item 147 knows to do two searches.

For clarity FIG. 14 does not show arrows coming from the app stores and other entities and going back to the Rater, and from the Rater to the mobile device that made the original query.

Suppose the Rater downloads the rating or ratings to Jane's mobile device. The app or Deep Linker that sent the deep link to the Rater might show the rating or ratings. Another case is as follows. Suppose an app sent the link. When it gets the reply, if the reply is not, say, 1 or 2 (if the rating is a scalar), the by default the app could send the deep link to the Deep Linker, to run it. Or, if it was the Deep Linker that sent the deep link to the Rater, then the Deep Linker can run the deep link. While if the rating is 1 or 2, then the app or Deep Linker might pop up a window showing this to Jane, asking if she wants to continue to run the deep link.

Related to this is a public safety issue. Suppose the Rater finds that a deep link involves an entity associated with unsafe products or with serious fraud or organised crime or terrorism. There could be implemented an emergency communication protocol between the Rater and the Deep Linker. The Rater uses this to tell the Deep Linker, which can then make more detailed and stronger worded warnings to the user. This can include making the user do several manual steps to have the deep link executed.

Suppose the Rater has access to information about the physical location of the device that made the deep link. This can also be a factor in the overall rating of the deep link. For example, suppose from earlier times the Rater found negative ratings of other deep links based on their network addresses. The Rater can try to correlate these addresses to physical locations. If now with a deep link presented to it, the Rater finds that its location is near other locations of bad deep links, then it can make a negative rating of the current link.

Suppose the deep link was on a web page, and the Rater gets the URL of this page along with the deep link. The URL and the contents of the page can be analysed by antispam methods or groups. The domain of the URL could be owned by a known or suspected spammer or phisher, for example. If so, this is important information that can be used to make a low rating of the deep link.

The previous section discussed forwarding a deep link, where the forwarding address was appended as a deep link to the original deep link. The forwarded deep link can be rated, just as was the original deep link. This gives more information that the Rater can use, and can present to the user if requested.

There might be an alert if any party in the forwarded deep link is found to be associated with spam or malware. For example, suppose in the deep link the app checks out ok. But the app instance comes from a network neighbourhood where nearby addresses are associated with spammers or, worse, malware. Maybe the instance user (Bob) is using a clean social app to try to induce others (Jane?) to interact with him. Per se, this might not be conclusive evidence against Bob. However presenting the evidence to Jane makes her aware or it and gives her more information to let her decide.

Suppose a forwarded deep link has a signature. If it was made using public key cryptography, it can be computationally intensive to verify. The Rater can do this. By caching the result that the signature was verified, if the deep link is later sent to the Rater by other devices, the Rater does not have to re-verify. Giving savings in computing.

Thus far this section focused on rating a deep link before a user, Jane, runs it. But suppose Jane does run it. During or after her interaction with whatever or whoever answers the deep link, she can also rate it. Her app might let her do this. It can upload this to the Rater. Which can then use it in future ratings. Either of an exact copy of this deep link, or of similar deep links. This can mean deep links with the same app and with different instance addresses.

Or her app might not let her rate it. Another method is via the Deep Linker, especially if it was the entity that called the Rater from her device.

An extra feature is present. When Jane rates the deep link, information about her might be uploaded to the Rater. Like an identifier of her app that she used to interact with the app in the deep link. And her network address. Maybe also her physical location or some fuzzified version of it. Of course, the id of her app and her network address is equivalent to another deep link, of her instead of Bob.

In turn, the Rater can apply some rules to try to rate Jane's credibility. For example, if she sends a rating of Bob's deep link just a few seconds after she got a rating of it from the Rater, this might be suspect. There might not be enough time for her to do a reliable rating if her interaction with Bob involves manual steps. This differs from how the Rater rated Bob's deep link. The Rater had no manual engagement with him and in general, the Rater should compute a rating as rapidly as possible, as discussed earlier. But when Jane and Bob interact, this is on human timescales.

Jane's rating of the deep link might by default just be a rating (on a scale of 1 to 5 perhaps) of the entire link. An alternative has her app letting her rate separately the app and the instance in the link. Maybe she really liked using or interacting with the app in the deep link, but she did not like the person she interacted with. So she will give the app a good rating and the instance address a bad rating. Here, a distinction can be made between if she interacted with that app via her app (e.g. by using a text window in her app), or whether she ran an instance of the deep link app. If she actually did the latter, her rating of the app might have a higher weight than if she did the former.

Another issue is if Jane uploads several ratings for the same app or deep link. She might be trying to over-vote to bias the average rating high or low. Likewise, if she uploads several ratings for different deep links with different apps in a short time interval. She could be doing a more indirect skewing of average ratings for those deep links or apps. The Rater can record the network addresses of users who upload ratings.

A further aspect relates to whether the Rater is asked for a rating about a deep link and whether Jane later makes a rating on that link. Suppose the Rater is asked and gives a negative rating. The rating might have several components, but imagine that overall the rating is “negative” (like an average 1 or 2 out of 5 in the earlier rating scale). Jane later gives a rating of the deep link. Now average this across all users that use the Rater for deep links for a given app. Then look across all apps in the links. The Rater can figure what percentage of them give negative ratings and what give positive. Likewise with positive ratings that the Rater gives. So the Rater can test across its ratings how much they are followed.

Thus in FIG. 14 there might be the extra resource on the Rater site, where the Rater consults its own database of uploaded reviews of deep links. For convenience, this is omitted from the Figure.

The Rater amasses various types of data. The reviews just mentioned. The queries of deep links from users. The addresses and apps of the user devices from which these queries emanate. Hence the Rater can make social networks, of users, apps, user network addresses. Plus the Rater functions as a specialised search engine.

9: Remarks;

This submission lets an app increase its reach for its users. When Jane is in a public area, she can find far more than just those who are using her app. Given that a major appeal of many apps is a large audience, this enhances the allure.

We claim:

1: A system of a mobile device Alpha, a first server, a second server and a device Rho; Alpha runs an app instance Beta that sends data of a location and a proximity measure to the first server; the first server sends the data to the second server; the second server returns results about a user with Rho, in proximity of the location; the results have a deep link; the deep link has an identifier of an app instance Phi running on Rho, and an address; Phi listens at the address; Beta shows the results; Beta uses the deep link to interact with Phi.

2: The system of claim 1, where the second server returns data about a plurality of users and devices.

3: The system of claim 1, where the first server contacts a plurality of secondary servers; the data from the latter are shown in a screen of Beta.

4: The system of claim 1, where the address includes a port number.

5: The system of claim 1, where Phi interacts with the second server; the second server makes a string; the second server associates the string with Phi; the string is inserted into the deep link in place of an address; the deep link is sent to Beta; Beta picks the data; Beta sends the string to the second server.

6: The system of claim 5, where the second server returns the address of Phi; Beta interacts with Phi.

7: The system of claim 5, where Beta interacts with Phi by sending messages to the second server; the second server relays the messages to Phi; Phi replies to the second server; the second server relays the replies to Beta.

8: The system of claim 1, where Beta uses the identifier of Phi in the deep link to install and run an instance of Phi on Alpha; the Phi instance on Alpha is given the address of the instance on Rho; the Phi instance interacts with the instance on Rho.

9: The system of claim 8, where Beta is credited by the second server with installing Phi on Alpha.

10: The system of claim 8, where the first server is credited by the second server with installing Phi on Alpha.

11: The system of claim 8, where the user of Beta is credited by the second server with installing Phi on Alpha.

12: The system of claim 1, where Phi gets text messages from Beta; Beta inserts a deep link into the text; the deep link has an identifier of Beta and an address of Beta; Beta listens on the address; Rho uses the deep link to run an instance of the app; Rho sends the instance the address of Beta; the Rho instance interacts with Beta.

13: The system of claim 12, where if the app is not present on Rho, Rho installs the app from the first server.

14: The system of claim 1, where Phi gets audio messages from Beta; Beta inserts a deep link or a representation of the deep link into the audio; the deep link has an identifier of the app and the address of Beta; Beta listens on the address; Rho extracts the deep link from the audio; Rho runs an instance of the app; Rho sends the instance the address of Beta; the Rho instance interacts with Beta.

15: The system of claim 14, where if the app is not present on Rho, Rho installs the app from the first server.

16: The system of claim 1, where Phi gets video from Beta; Beta inserts a deep link or a representation of the deep link into the video; the deep link has an identifier of the app and the address of Beta; Beta listens on the address; Rho extracts the deep link from the video; Rho runs an instance of the app; Rho sends the instance the address of Beta; the Rho instance interacts with Beta.

17: The system of claim 16, where the deep link is encoded as a barcode; Rho uses a barcode decoder to extract the deep link.

18: The system of claim 16, where the deep link is shown as text; Rho uses Optical Character Recognition to extract the deep link.

19: A system of a first device Alpha, a second device Psi and a server; Psi makes a deep link with an identifier of an app, and a first address of Psi; Psi runs the app; the app contacts the server; the server records the first address; Alpha gets the deep link; Psi gets a second address; the app contacts the server; the server records the second address; Alpha runs the deep link; Alpha contacts the server with the first address; the server returns the second address; Alpha runs an instance of the app; the instance contacts Psi at the second address.

20: A system of a Rater website and a mobile device; the Rater gets a deep link from the mobile device; the Rater sends an app identifier in the deep link to a set of app stores; the app stores return ratings; the Rater computes a representative rating Phi; the Rater sends an address of an app instance in the deep link to an antispam organisation; the antispam organisation returns a rating Chi; the Rater sends Phi and Chi to the mobile device.
